(19) United States
(12) Patent Application Publication
(10) Pub. No.: US 2010/0092749 A1
(43) Pub. Date: Apr. 15, 2010

(54) USE OF AN IRON-CHROMIUM-ALUMINUM ALLOY WITH LONG SERVICE LIFE AND MINOR CHANGES IN HEAT RESISTANCE

(75) Inventors: Heike Hattendorf, Werdohl (DE); Janine Lindemann, Dortmund (DE); Rainer Rueffert, Essen (DE)

Correspondence Address: JORDAN AND HAMBURG LLP, 122 EAST 42ND STREET, SUITE 4000, NEW YORK, NY, 10168, US

(73) Assignee: THYSSENKRUPP VDM GMBH, Werdohl (DE)

(21) Appl. No.: 12/449,127

(22) PCT Filed: Jan. 15, 2008
(86) PCT No.: PCT/DE2008/000061

§ 371 Date: Jul. 23, 2009

(30) Foreign Application Priority Data
Jan. 29, 2007 (DE) 10 2007 005 154.0

(51) Int. Cl. B32B 15/00; C22C 38/42; C22C 38/44; C22C 38/46; C22C 38/50; C22C 38/54; C22C 38/02

(52) U.S. Cl. 428/220

(57) ABSTRACT

Use of an iron-chromium-aluminum alloy with long service life and minor changes in heat resistance as a foil for heating elements, the foil having a thickness ranging from 0.020 to 0.300 μm. The alloy contains (in percentages by weight) 4.5-6.5% Al and 16-24% Cr, to which are added 0.05-0.7% Si, 0.001-0.5% Mn, 0.02-0.1% Y, 0.02-0.1% Zr, 0.02-0.1% Hf, 0.003-0.020% C, maximum 0.03% N, maximum 0.01% S and maximum 0.5% Cu, the remainder being iron and the usual impurities resulting from the melting process.

### BACKGROUND OF THE INVENTION

The invention relates to the use of an iron-chromium-aluminum alloy that is produced using fusion metallurgy and that has a long service life and minor changes in heat resistance.

Such alloys are used for producing electrical heating elements and catalyst substrates. These materials form a dense, adherent aluminum oxide layer that protects them against damage at high temperatures (e.g. up to 1400° C.). This protection is enhanced by the addition of so-called reactive elements such as for instance Ca, Ce, La, Y, Zr, Hf, Ti, Nb, V, which inter alia improve the adhesive power of the oxide layer and/or reduce layer growth, as is described for instance in Ralf Bürgel, “Handbook of High Temperature Materials Engineering”, Vleweg Verlag, Braunschweig 1998, starting on page 274.

The aluminum oxide layer protects the metal material from rapid oxidation. It also grows itself, although very slowly. This growth consumes the aluminum content of the material. If there is no more aluminum available, other oxides grow (chromium oxide and iron oxide), the metal content of the material is consumed very rapidly, and the material fails due to destructive corrosion. The time to failure is defined as the service life. Increasing the aluminum content extends service life.

Known from WO 02/20197 is a ferritic, non-rusting steel alloy, in particular for use as a heat conductor element. The alloy is formed using an FeCrAl alloy produced using powder metallurgy and contains (in mass %) less than 0.01% C, ≦0.5% Si, ≦0.2% Mn, 10.0 to 40.0% Cr, ≦0.6% Ni, ≦0.01% Cu, 2.0 to 10.0% Al, one element or a plurality of elements from the group of reactive elements such as Sc, Y, La, Ce, Ti, Zr, Hf, V, Nb, Ta, in contents between 0.1 and 1.0%, and the remainder iron and unavoidable impurities. DE-A 199 28 842 describes an alloy having (in weight %) 16 to 22% Cr, 6 to 10% Al, 0.02 to 1.0% Si, max. 0.5% Mn, 0.02 to 0.1% Hf, 0.02 to 0.1% Y, 0.001 to 0.01% Mg, max. 0.02% Ti, max. 0.03% Zr, max. 0.02% SE [rare earth metals], max. 0.1% Sr, max. 0.1% Ca, max. 0.5% Cu, max. 0.1% V, max. 0.1% Ta, max. 0.1% Nb, max. 0.03% C, max. 0.01% N, max. 0.01% B, and the remainder iron and impurities caused by melting, for use as a substrate film for exhaust gas catalytic converters, as heat conductors, and as components in industrial furnace construction and in gas burners.

EP-B 0 387 670 describes an alloy having (in weight %) 20 to 25% Cr, 5 to 8% Al, 0.03 to 0.08% yttrium, 0.004 to 0.008% nitrogen, 0.020 to 0.040% carbon, and approximately equal parts 0.035 to 0.07% Ti and 0.035 to 0.07% zirconium, and max. 0.01% phosphorus, max. 0.01% magnesium, max. 0.5% manganese, max. 0.005% sulfur, and the remainder iron, the sum of the contents of Ti and Zr being 1.75 to 3.5 times greater than the percentage sum of the contents of C and N, and impurities caused by melting. Ti and Zr can be replaced entirely or in part by hafnium and/or tantalum or vanadium.

EP-B 0290 719 describes an alloy having (in weight %) 12 to 30% Cr, 3.5 to 8% Al, 0.008 to 0.10% carbon, max. 0.8% silicon, 0.10 to 0.4% manganese, max. 0.035% phosphorus, max. 0.020% sulfur, 0.1 to 1.0% molybdenum, max. 1% nickel, and additions of 0.010 to 1.0% zirconium, 0.003 to 0.3% titanium, and 0.003 to 0.3% nitrogen, calcium plus magnesium 0.005 to 0.05%, and rare earth metals from 0.003 to 0.80%, niobium 0.5%, and the remainder iron with the usual accompanying elements, which for instance is used as wire for heating elements for electrically heated ovens and as a construction material for thermally loaded parts and as a film for producing catalyst substrates.

U.S. Pat. No. 4,277,374 describes an alloy having (in weight %) up to 26% chromium, 1 to 8% aluminum, 0.02 to 2% hafnium, up to 0.3% yttrium, up to 0.1% carbon, up to 2% silicon, and the remainder iron, having a preferred range of 12 to 22% chromium and 3 to 6% aluminum, which alloy is used as a film for producing catalyst substrates.

Known from U.S. Pat. No. 4,414,023 is a steel having (in weight %) 8.0 to 25.0% Cr, 3.0 to 8.0% Al, 0.002 to 0.06% rare earth metals, max. 4.0% Si, 0.06 to 1.0% Mn, 0.035 to 0.07% Ti, 0.035 to 0.07% Zr, including unavoidable impurities.

The article by I. Gurrappa, S. Weinbruch, D. Naumenko, and W. J. Quadakkers, Materials and Corrosions 51 (2000), pages 224 to 235, describes a detailed model of the service life of iron-chromium-aluminum alloys. The article describes a model in which the service life of iron-chromium-aluminum alloys are to be dependent depending on the aluminum content and the specimen shape, potential spalling not yet being accounted for in this formula.

$${t}_{B} = {[ 4.4 \times {10}^{- 3} \times ( {C}_{o} - {C}_{B} ) \times \frac{ρ * f}{k} ]}^{\frac{1}{n}} where$$

$$f = 2 \times \frac{Volume}{Surface}$$

t_{B}=service life, defined as time until oxides other than aluminum oxide occur
C₀=aluminum concentration at the onset of oxidation
C_{B}=aluminum concentration at the occurrence of oxides other than aluminum oxides
ρ=specific density of the metal alloy
k=oxidation speed constant
n=oxidation speed exponent

When spalling is accounted for, the following formula results for a flat specimen having infinite width and length and a thickness of d (f=d):

$${t}_{B} = 4.4 \times {10}^{- 3} \times ( {C}_{o} - {C}_{B} ) \times ρ \times d \times {k}^{- \frac{1}{n}} \times {( Δ {m}^{*} )}^{\frac{1}{n} - 1}$$

where Δm* is the critical change in weight at which the spalling begins.

Both formulas express that the service life grows shorter as the aluminum content grows smaller and as the ratio of large surface to volume (or small specimen thickness) decreases.

This becomes significant if thin films in the dimensional range of approx. 20 μm to approx. 300 μm must be employed for the application.

Heat conductors that comprise thin films (e.g. approx. 20 to 300 μm thickness with a width in the range of one or several millimeters) are distinguished by a large surface-to-volume ratio. This is advantageous when rapid heating and cooling times are desired, for instance as they are required in the heat conductors used in glass ceramic surfaces so that heating up can be noticeably rapid and so that rapid heating can be attained as in a gas cooker. At the same time, however, the large surface-to-volume ratio is disadvantageous for the service life of the heat conductor.

When using an alloy for a heat conductor, the behavior of the heat resistance must also be considered. As a rule a constant voltage is applied to the heat conductor. If the resistance remains constant during the course of the service life of the heating element, the current and the output of this heating element do not change, either.

However, this is not the case due to the processes described in the foregoing, in which aluminum is consumed continuously. Because of the aluminum consumption, the specific electrical resistance of the material decreases. However, this occurs in that atoms are removed from the metal matrix, i.e. the cross-section becomes smaller, which results in an increase in resistance (see also Harald Pfeifer, Hans Thomas, Zunderfeste Legierungen [Ignition-resistant alloys], Springer Verlag, Berlin/Göttingen/Heidelberg/1963, page 111). Then, due to the voltages when the oxide layer grows and due to the different expansion coefficients of metal and oxide, when the heat conductor heats up and cools off additional voltages occur that can cause a deformation in the film and therefore a dimensional change (see also H. Echsler, H. Hattendorf, L. Singheiser, W. J. Quadakkers, Oxidation behaviour of Fe—Cr—Al alloys during resistance and furnace heating, Materials and Corrosion 57 (2006) 115-121). Depending on the interaction of the dimensional changes with the change in the specific electrical resistance, there can be an increase or a reduction in the heat conductor heat resistance during the course of the useful life.

As a rule the heat resistance in wire made of iron-chromium-aluminum alloys increases with time (Harald Pfeifer, Hans Thomas, Zunderfeste Legierungen, Springer Verlag, Berlin/Göttingen/Heidelberg/1963, page 112); as a rule the heat resistance in heat conductors in the form of film made of iron-chromium-aluminum alloys decreases with time (FIG. 1).

If the heat resistance R_{W} increases over time, the output P, calculated as P=U*I=U²/R_{W}, drops when the voltage is kept constant on the heating element made of it. As the output on the heating element drops, the temperature of the heating element also drops. The service life of the heat conductor, and thus also of the heating element, is extended. However, for heating elements there is often a lower limit for the output so that this effect is not always useful for extending service life. In contrast, if the heat resistant R_{W} drops over the course of time, the output P increases when voltage is kept constant on the heating element. However, as output increases, temperature also increases, and thus the service life of the heat conductor or heating element is shortened. Thus the deviations in the heat resistance as a function of time should be kept in a narrow range near zero.

The service life and the behavior of the heat resistance can be measured e.g. in an accelerated service life test. Such a test is described e.g. on page 113 of Harald Pfeifer, Hans Thomas, Zunderfeste Legierungen, Springer Verlag, Berlin/Göttingen/Heidelberg/1963. It is performed using a 120 s switching cycle at constant temperature on wire that has a 0.4 mm diameter and that has been shaped into coils. The proposed testing temperature is 1200° C. or 1050° C. However, since in this case the issue is in particular the behavior of thin films, the test was performed as follows: Film strips that were 50 μm thick and 6 mm wide were held between two current feedthroughs and heated up to 1050° C. by applying a voltage. Heating to 1050° C. occurred for 15 s, then the current feed was interrupted for 5 s. At the end of the service life, the film failed in that the remaining cross-section melted through. During the service life test the temperature was measured automatically using a pyrometer and where needed was corrected to the target temperature using the program control.

The burning period is taken as a measure for service life. Burning period or burning time is the addition of the times in which the specimen was heated. The burning period is the time until specimen failure, and burning time is the running time during one experiment. In each of the following figures and tables, the burning period and the burning time are provided in % as values relative to the burning period of a reference specimen and are called relative burning period and relative burning time.

It is known from the prior art described in the foregoing that small additions of Y, Zr, Ti, Hf, Ce, La, Nb, V, have a major effect inter alia on the service life of FeCrAl alloys.

The market imposes increased demands on the products, which require a longer service life and an increased employment temperature for the alloys.

### SUMMARY OF THE INVENTION

The underlying object of the invention is to provide an iron-chromium-aluminum alloy for the specific application area, which alloy has a longer service life than the previously used iron-chromium-aluminum alloys and simultaneously has a minor change in the heat resistance over time at the application temperature, in particular when used as a film in a defined dimensional range.

This object is attained with the use of an iron-chromium-aluminum alloy having a long service life and a minor change in heat resistance as a film for heating elements in the dimensional range of 0.020 to 0.300 mm thickness, having (in weight %) 4.5 to 6.5% Al, 16 to 24% Cr, and additions of 0.05 to 0.7% Si, 0.001 to 0.5% Mn, 0.02 to 0.1% Y, 0.02 to 0.1% Zr, 0.02 to 0.1% Hf, 0.003 to 0.020% C, max. 0.03% N, max. 0.01% S, max. 0.5% Cu, and the remainder iron and the usual impurities caused by melting.

Advantageous refinements of the subject matter can be taken from the subordinate claims. Moreover, the alloy should advantageously be melted with 0.0001 to 0.05% Mg, 0.0001 to 0.03% Ca, and 0.010 to 0.030% P in order to be able to create optimum material properties in the film.

Moreover, the element Y can be entirely or partially replaced with at least one of the elements Sc and/or La and/or Ce, ranges between 0.01 and 0.1 weight %, preferably 0.02 and 0.1 weight % being possible in the case of partial substitution.

Moreover, the element Hf can be entirely or partially replaced with at least one of the elements Sc and/or Ti and/or V and/or Nb and/or Ta and/or La and/or Ce, ranges between 0.01 and 0.1 mass % being possible in the case of partial substitution.

Advantageously, the alloy can be melted with (in weight %) max. 0.02% N and max. 0.005% S.

Other preferred proportions of constituents, in weight %, are: 4.8 to 6.2% Al; 5.0 to 5.8% Al; 4.8 to 5.5& Al; 5.5 to 6.3% Al; 18 to 23% Cr; 19 to 22% Cr; 0.05 to 0.5% Si; 0.005 to 0.5% Mn; 0.03 to 0.1% Y; 0.02 to 0.08 Zr; 0.0001 to 0.03% Mg; 0.0001 to 0.02% Mg; 0.0002 to 0.01% Mg; 0.0001 to 0.02% Ca; 0.0002 to 0.01% Ca; 0.010 to 0.025% P; 0.010 to 0.022% P; max. 0.02% N; max. 0.01% N; max. 0.005% S; max. 0.003% S; max. 0.5% Ni; max. 0.1% Mo; max. 0.1% W.

Preferred Fe—Cr—Al alloys for use as a heating element are distinguished by the following composition (in weight %):

| | | |
|---|---|---|
| Al | 4.8-6.2% | 5.0-5.8% |
| Cr | 18-23% | 19-22% |
| Si | 0.05-0.5% | 0.05-0.5% |
| Mn | 0.005-0.5% | 0.005-0.5% |
| Y | 0.03-0.1% | 0.03-0.1% |
| Zr | 0.02-0.08% | 0.02-0.08% |
| Hf | 0.02-0.10% | 0.02-0.10% |
| C | 0.003-0.020% | 0.003-0.020% |
| Mg | 0.0001-0.03% | 0.0001-0.02% |
| Ca | 0.0001-0.02% | 0.0001-0.02% |
| P | 0.010 to 0.025% | 0.010 to 0.022 |
| S | Max. 0.01% | Max. 0.01% |
| N | Max 0.03% | Max. 0.03% |
| Cu | Max. 0.5% | Max. 0.5% |
| Ni | Max. 0.5% | Max. 0.5% |
| Mo | Max. 0.1% | Max. 0.1% |
| W | Max. 0.1% | Max. 0.1% |
| Fe | Remainder | Remainder |

The use of the alloy as a film heat conductor for employment in glass ceramic cooking surfaces is also preferred. Moreover, use for employment as a substrate film in heatable metal exhaust gas catalytic converters is preferred.

### BRIEF DESCRIPTION OF THE DRAWINGS

FIGS. 1-5 each depict the progression of the heat resistance in the service life test on film for the alloys T3, L1-L3 according to the prior art, and the inventively windable lot E1.

FIG. 1 Progression of heat resistance in service life test on films for lot T3

FIG. 2 Progression of heat resistance in service life test on films for lot L1

FIG. 3 Progression of heat resistance in service life test on films for lot L2

FIG. 4 Progression of heat resistance in service life test on films for lot L3

FIG. 5 Progression of heat resistance in service life test on films for lot E1

### DETAILED DESCRIPTION OF THE INVENTION

The details and advantages of the invention are explained in greater detail in the following examples.

Table 1 depicts the iron-chromium-aluminum alloys T1 through T3, L1 through L3, and the inventive alloy E1, which have been produced on an industrial scale. After the alloy was melted, films having this composition were produced using ingot casting or continuous casting and hot and cold forming with any necessary intermediate annealing process(es).

For the service life test described in the foregoing for industrial scale production, a specimen having a 50 μm strip thickness is removed and cut to a width of approx. 6 mm and subjected to the service life test for films.

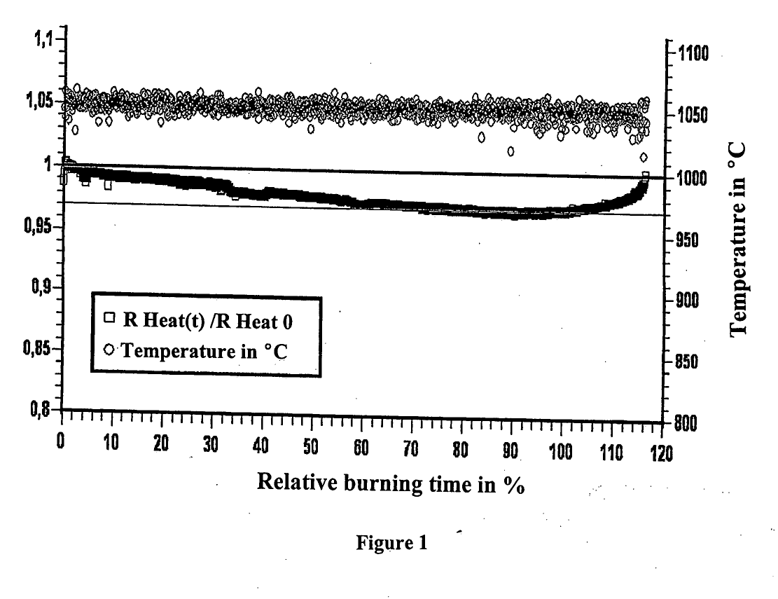

FIG. 1 illustrates the heat resistance progression in the heat conductor test for films described in the foregoing on one of the iron-chromium-aluminum alloys, Aluchrom Y, having a composition of 20 to 22% chromium, 5 to 6% aluminum, 0.01% to 0.1% carbon, max. 0.5% Mn, max. 0.3% Si, additions of 0.01 to 0.15% Y, 0.01 to 0.1% Zr, and 0.01 to 0.1% Ti, which is employed e.g. as a heat conductor. The resistance is relative to its initial value at the beginning of the measurement. There is a drop in the heat resistance. Toward the end of the progression, shortly prior to the specimen burning through, the heat resistance increases sharply (starting at approx. 100% relative burn time in FIG. 1). In the following, the maximum deviation of the heat resistance ratio from the initial value 1.0 at the beginning of the experiment (or shortly after the start after contact resistance has formed) to the beginning of the sharp increase is called A_{W}.

This material typically has a relative burning period of approx. 100%, as examples T1 through T3 in Table 1 demonstrate.

The results of the service life tests can be found in Table 1. Each relative burning period listed in Table 1 is the mean value of at least three specimens. Moreover, the A_{W} found for each lot has been entered into the table. T1 through T3 are 3 lots of the iron-chromium-aluminum alloys Aluchrom Y according to the prior art, having a composition of approx. 20% chromium, approx. 5.2% aluminum, approx. 0.03% carbon, and additions of Y, Zr, and Ti, each at approximately 0.05%. These lots attain a relative burning period of 96% (T1) to 124% (T3) and an excellent value of from −2 to −3% for AW.

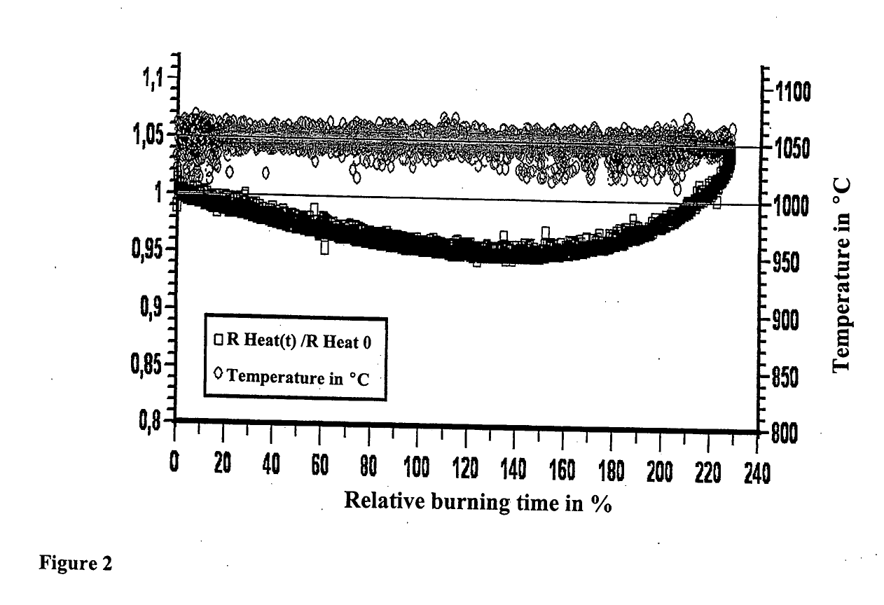

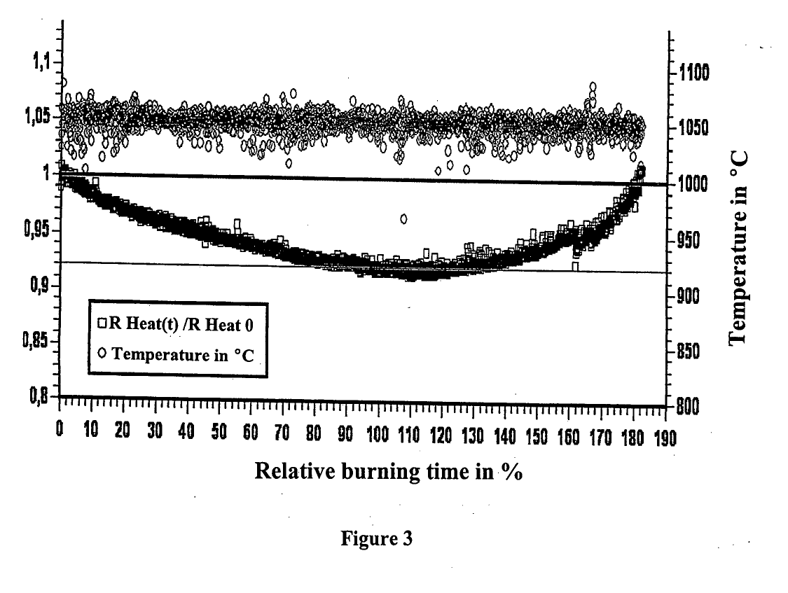

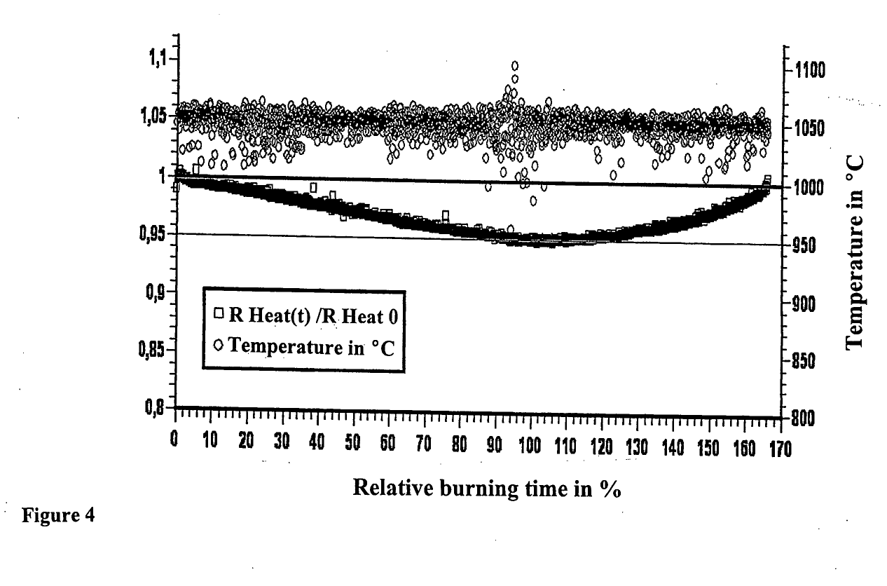

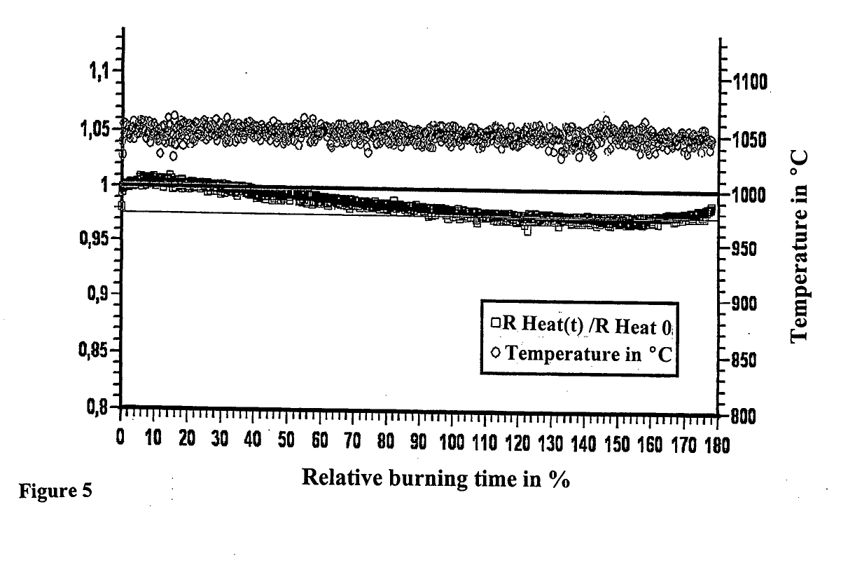

Moreover, Table 2 contains entries for lots L1 and L2 for the material Aluchrom YHf according to the prior art, having 19 to 22% Cr, 5.5 to 6.5% aluminum, max. 0.5% Mn, max. 0.5% Si, max. 0.05% carbon, and additions of max. 0.10% Y, max. 0.07% Zr, and max. 0.1% Hf. This material is used e.g. for a film for catalyst substrates, but also for heat conductors. When lots L1 and L2 are subjected to the heat conductor test for films described in the foregoing, the increased service life of L1, at 188%, and L2, at 152%, is clearly evident. L1 has a longer service life than L2, which can be explained by the aluminum content that has been increased from 5.6 to 5.9%. Unfortunately, this alloy has an A_{W} of −5% for L1 (FIG. 2) and −8% for L2 (FIG. 3). In particular an A_{W} of −8% is too high and experience has shown it leads to a clear increase in component temperature, which offsets the longer service life of this material and thus does not provide any advantage overall.

L3 is a variant of the material Aluchrom YHf according to the prior art, having an increased aluminum content of 7%. At 153%, the relative burning period is similar only to that of L2, at 5.6% Al, and is even less than that of L1, at 5.9% Al. Increasing the aluminum content to 7% does not seem to further increase the service life of heat conductor films.

E1 is an alloy that can be employed in accordance with the invention for films in application areas of 0.020 to 0.300 mm thickness. At 189%, it has the desired long relative burning period and, with an A_{W} of −3%, it also has very favorable heat resistance, similar to the lots in accordance with the prior art T1 through T3. Like L1 and L2, E1 is an iron-chromium-aluminum alloy having 19 to 22% Cr, 5.5 to 6.5% aluminum, max. 0.5% Mn, max. 0.5% Si, max. 0.05% carbon, and additions of max. 0.10% Y, max. 0.07% Zr, and max. 0.1% Hf. However, in contrast to L1 and L2, it has a very low carbon content of only 0.007%. L1 has an A_{W} of −5% with a carbon content of 0.026%, and L2 has an A_{W} of −8% with a carbon content of 0.029%. L1 and L2 are comparable with E1 in terms of the elements Fe, Cr, Mn, Si, S, N, Y, Zr, Hf, Ti, Nb, Cu, P, Mg, Ca, and V.

Thus A_{W} appears to be highly dependent on carbon comment. Since it is very possible for the carbon content in the semi-finished product to rise somewhat during the production process, the carbon content in the finished film was analyzed. The results for L1, L3, and E1 were within the range of analytic tolerance, but in L2 the carbon content, at 0.037%, was clearly higher (see Table 1). This explains the particularly high A_{W} value, −8%, and once more underscores the importance of preventing contamination with carbon. The carbon content should be kept to less than 0.02% to obtain a good A_{W} value.

Thus, the claimed limits for the alloy to be used for film can be established individually as follows:

A minimum content of 0.02% Y is necessary to obtain the effect of Y increasing oxidation resistance. Due to cost factors, the upper limit is set at 0.1 weight %.

A minimum content of 0.02% Zr is necessary to obtain a good service life and a low A_{W}. Due to cost factors, the upper limit is set at 0.1 weight % Zr.

A minimum content of 0.02% Hf is necessary to obtain the effect of Hf increasing oxidation resistance. Due to cost factors, the upper limit is set at 0.1 weight % Hf.

The carbon content should be less than 0.020% to obtain a low A_{w} value. It should be greater than 0.003% to ensure processability.

The nitrogen content should be a maximum of 0.03% to prevent formation of nitrides, which have a negative impact on processability.

The phosphorus content should be less than 0.030%, since this surfactant element limits oxidation resistance. Costs increase if the P content is too low. Therefore the P content is greater than or equal to 0.010%.

The sulfur content should be kept as low as possible because this surfactant element limits oxidation resistance. Therefore max. 0.01% S is set.

Chromium contents between 16 and 24 mass % do not have a major effect on service life, as can be seen in J. Klöwer, Materials and Corrosion 51 (2000), pages 373 to 385. However, a certain chromium content is necessary, because chromium promotes the formation of the α-Al₂O₃ layer, which is an especially stable and protective layer. Therefore the lower limit is 16%. A chromium >24% has a negative impact on alloy processability.

An aluminum content of at least 4.5% is necessary to obtain an alloy having sufficient service life. Al contents >6.5% do not increase service life in film heat conductors.

According to J. Klöwer, Materials and Corrosion 51 (2000), pages 373 to 385, additions of silicon increase the service life by improving the adhesion of the cover layer. Therefore a content of at least 0.05 weight % silicon is necessary. A silicon content that is too high has a negative effect on alloy processability. The upper limit is therefore 0.7%.

A minimum content of 0.001% Mn is necessary for improving processability. Manganese is limited to 0.5%, since this element reduces oxidation resistance.

Copper is limited to max. 0.5%, since this element reduces oxidation resistance. The same is true of nickel.

Molybdenum is limited to max. 0.1%, since this element reduces oxidation resistance. The same is true of tungsten.

The contents of magnesium and calcium are adjusted in spread range of 0.0001 to 0.05 weight % and 0.0001 to 0.03 weight %, respectively.

TABLE 1
Composition, relative burning period, and A_{w} for alloys investigated. All figures in
weight %.

| Aluchrom | Y | Y | Y | YHf | YHf | YHf Al | YHf (SO) |
|---|---|---|---|---|---|---|---|
| Lot (VDM) | 58860 | 59651 | 153275 | 152891 | 55735 | 58323 | 153190 |
| Lot | T1 | T2 | T3 | L1 | L2 | L3 | E1 |
| Fe (R) | 73.3 | 73.1 | 73.2 | 7.31 | 73.2 | 71.8 | 73.0 |
| Cr | 20.9 | 20.8 | 20.7 | 20.0 | 20.3 | 20.3 | 20.1 |
| Al | 5.1 | 5.1 | 5.2 | 5.9 | 5.6 | 7.0 | 6.0 |
| Mn | 0.21 | 0.26 | 0.22 | 0.18 | 0.20 | 0.20 | 0.12 |
| Si | 0.13 | 0.17 | 0.15 | 0.25 | 0.28 | 0.27 | 0.33 |
| Ni | 0.15 | 0.19 | 0.17 | 0.17 | 0.15 | 0.14 | 0.18 |
| Mo | 0.01 | 0.01 | <0.01 | <0.01 | 0.01 | 0.013 | <0.01 |
| C | 0.033 | 0.033 | 0.035 | 0.026 | 0.029 | 0.024 | 0.007 |
| C, analysis on | | | | 0.028 | 0.037 | 0.024 | 0.008 |
| film, 50 μm | | | | | | | |
| S | <0.001 | <0.001 | 0.001 | 0.001 | 0.002 | <0.001 | 0.002 |
| N | 0.006 | 0.006 | 0.006 | 0.005 | 0.004 | 0.004 | 0.007 |
| Y | 0.04 | 0.05 | 0.04 | 0.05 | 0.06 | 0.05 | 0.05 |
| Zr | 0.05 | 0.05 | 0.04 | 0.05 | 0.05 | 0.06 | 0.04 |
| Hf | <0.01 | <0.01 | <0.01 | 0.04 | 0.03 | 0.03 | 0.03 |
| Ti | 0.05 | 0.08 | 0.04 | <0.01 | 0.01 | <0.01 | <0.01 |
| Nb | <0.01 | <0.01 | <0.01 | <0.01 | <0.01 | <0.01 | 0.01 |
| Cu | 0.01 | 0.02 | 0.03 | 0.02 | 0.07 | 0.02 | 0.02 |
| P | 0.012 | | 0.012 | 0.012 | 0.013 | 0.012 | 0.011 |
| Mg | 0.009 | 0.010 | 0.010 | 0.009 | 0.007 | 0.010 | 0.008 |
| Ca | 0.003 | 0.002 | 0.002 | 0.001 | 0.001 | 0.003 | 0.0004 |
| V | 0.06 | 0.04 | 0.05 | 0.08 | 0.05 | 0.05 | 0.040 |
| W | <0.01 | 0.01 | 0.02 | — | — | <0.01 | 0.02 |
| B | — | — | <0.001 | 0.001 | — | — | 0.001 |
| Relative burning | 91 ± 8 | 105 ± 20 | 124 ± 8 | 188 ± 33 | 152 ± 14 | 153 ± 22 | 189 ± 19 |
| period ± s in %, | | | | | | | |
| film 50 μm × 6 mm, | | | | | | | |
| 1050° C., 15 s | | | | | | | |
| “on”/5 s “off” | | | | | | | |
| A_{w} in % | −2 | −2 | −3 | −5 | −8 | −5 | −3 |

1. A heating or other thermally conductive element, comprising a 0.020 to 0.300 mm thick film of an alloy comprised of, by weight, 4.5 to 6.5% Al, 16 to 24% Cr, 0.05 to 0.7% Si, 0.001 to 0.5% Mn, 0.02 to 0.1% of at least one element selected from a first group consisting of Y, Sc, La and Ce, 0.02 to 0.1% Zr, 0.02 to 0.1% of at least one of element selected from a second group consisting of Hf, Sc, Ti, V, Nb, Ta, La and Ce, 0.003 to 0.020% C, max. 0.03% N, max. 0.01% S, max. 0.5% Cu, and the remainder iron and the usual impurities caused by melting.

2. The element in accordance with claim 1, wherein Al content, by weight, of the alloy is 4.8 to 6.2%.

3. The element in accordance with claim 1, wherein Al content, by weight, of the alloy is 5.0 to 5.8%.

4. The element in accordance with claim 1, wherein Al content, by weight, of the alloy is 4.8 to 5.5%.

5. The element in accordance with claim 1, wherein Al content, by weight, of the alloy is 5.5 to 6.3%.

6. The element in accordance with claim 1, wherein Cr content, by weight, of the alloy is 18 to 23%.

7. The element in accordance with claim 1, wherein Cr content, by weight, of the alloy is 19 to 22%.

8. The element in accordance with claim 1, wherein Si content, by weight, of the alloy is 0.05 to 0.5%.

9. The element in accordance with claim 1, wherein Mn content, by weight, of the alloy is 0.005 to 0.5%.

10. The element in accordance claim 1, wherein Y content, by weight, of the alloy is 0.03 to 0.1%.

11. The element in accordance claim 1, wherein Zr content, by weight, of the alloy is 0.02 to 0.08%.

12. The element in accordance claim 1, wherein the alloy comprises, by weight, 0.02 to 0.1% Hf.

13. (canceled)

14. The element in accordance with claim 1, wherein the alloy further comprises Mg, Ca and P in the following respective proportions, by weight: 0.0001 to 0.05%, 0.0001 to 0.03%, and 0.010 to 0.030%.

15. The element in accordance with claim 14, wherein Mg content, by weight, of the alloy is 0.0001 to 0.03%.

16. The element in accordance with claim 14, wherein Mg content, by weight, of the alloy is 0.0001 to 0.02%.

17. The element in accordance with claim 14, wherein Mg content, by weight, of the alloy is 0.0002 to 0.01%.

18. The element in accordance claim 14, wherein Ca content, by weight, of the alloy is 0.0001 to 0.02%.

19. The element in accordance with claim 14, wherein Ca content, by weight, of the alloy is 0.0002 to 0.01%.

20. The element in accordance with claim 14, wherein P content, by weight, of the alloy is 0.010 to 0.025%.

21. The element in accordance with claim 14, wherein P content, by weight, of the alloy is 0.010 to 0.022%.

22. The element in accordance with claim 1, wherein Y is not present in the alloy.

23. The element in accordance with claim 1, wherein Y is present in the alloy along with, by weight, 0.02 to 0.1% of at least one of the elements Sc, La or Ce.

24. The element in accordance with claim 1, wherein Hf is not present in the alloy.

25. The element in accordance with claim 1, wherein Hf is present in the alloy with, by weight, 0.01 to 0.1% of at least one of the elements Sc, Ti V, Nb, Ta, La or Ce.

26. The element in accordance with claim 1, wherein N and S content, by weight, of the alloy are respectively max. 0.02% and max. 0.005%.

27. The element in accordance with claim 1 wherein N and S content, by weight, of the alloy are respectively max. 0.01% and max. 0.003%.

28. The element in accordance with claim 1, wherein the alloy further comprises at least one of Ni, Mo or W in the following respective proportions, by weight: max. 0.5%, max. 0.1%, and max 0.1% W.

29. The heating element in accordance with claim 1, wherein the heating element is electrically heatable.

30. The element in accordance with claim 1, wherein the thickness of the film is 20 to 200 μm.

31. The element in accordance with claim 1, wherein the thickness of the film is 20 to 100 μm.

32. A cooking surface provided with the heating element in accordance with claim 1.

33. A heatable metal exhaust gas catalytic converter comprising the alloy in accordance with claim 1 as a substrate film.

34. A fuel cells cell comprising the element in accordance with claim 1.

35. A glass ceramic cooking surface provided with the heating element of claim 1.
